(19) United States
(12) Patent Application Publication
(10) Pub. No.: US 2026/0281525 A1
(43) Pub. Date: Sep. 17, 2026

(54) IMAGE SENSOR SYSTEM

(71) Applicant: ZF Friedrichshafen AG, Friedrichshafen (DE)

(72) Inventor: Bharath Narahari, Farmington Hills, MI (US)

(73) Assignee: ZF Friedrichshafen AG, Friedrichshafen (DE)

(21) Appl. No.: 19/168,886

(22) PCT Filed: Apr. 3, 2024
(86) PCT No.: PCT/US2024/022781

§ 371 Date: Sep. 25, 2025

Related U.S. Application Data
(60) Provisional application No. 63/494,020, filed on Apr. 4, 2023.

(51) Int. Cl. H04N 23/54; H04N 23/51; H04N 23/55

(52) U.S. Cl. CPC H04N 23/54; H04N 23/51; H04N 23/55

(57) ABSTRACT

An image sensor system is disclosed. The image sensor system includes a housing assembly defining a cavity between a first edge and a second edge of the housing assembly. A printed circuit board is received within the cavity. The printed circuit board assembly has a first peripheral edge and a second peripheral edge. An adhesive material is disposed, i.e., dispensed, between the first peripheral edge and the first edge of the housing assembly and between the second peripheral edge and the second edge of the housing assembly.

### CROSS-REFERENCE TO RELATED APPLICATION

This application claims priority to U.S. Provisional Application No. 63/494,020, filed Apr. 4, 2023, the disclosure of which is incorporated herein by reference in its entirety.

### TECHNICAL FIELD

The disclosure relates to electronics, and more specifically, relates to a camera assembly that includes a fixation arrangement for an image sensor assembly to reduce roll, pitch and yaw tolerances.

### BACKGROUND

In some known camera assembly arrangements, tolerances related to roll, yaw, and pitch can deteriorate when mounting a lens assembly of an image sensor system to a housing. However, mounting a camera in a housing is beneficial in that the housing may host an onboard processing unit that allows for processing images from the camera in a single unit, as opposed to having to connect the camera to a separate processing unit, such as to a vehicle onboard processing unit.

In certain camera arrangements, an image sensor assembly is typically fixed with respect to a housing. When mounting the image sensor assembly to the hosing, one or more of the roll, yaw and/or pitch tolerances may deteriorate due to rotational forces exerted on a lens assembly when fasteners that attach the lens assembly to the housing experience torque. For example, in these designs, the lens of the image sensor assembly is adjusted for focusing. However, these designs do not compensate for roll. Also, adjustment of the lens can cause a shift with respect to mounting features that in turn results in installation issues and larger tolerance issues.

What is needed is an arrangement to ensure proper alignment of the lens assembly when attached to an image sensor assembly housing, thereby allowing for more flexibility in camera unit design, such as allowing for the camera unit to carry an onboard processing unit.

### SUMMARY

An image sensor system is disclosed. The image sensor system includes a housing assembly defining a cavity between a first edge and a second edge of the housing assembly. A printed circuit board assembly is also received within the cavity. The printed circuit board assembly has a first peripheral edge and a second peripheral edge. An adhesive material is disposed, i.e., dispensed, between the first peripheral edge and the first edge of the housing assembly and between the second peripheral edge and the second edge of the housing assembly.

In an exemplary arrangement, the housing assembly defines a lens receiving aperture that is configured to receive a lens barrel of a lens assembly. The printed circuit board assembly is part of an image sensor assembly includes the lens assembly.

In one exemplary arrangement, the adhesive material comprises an epoxy cationic material. The adhesive material is curable by a UV light.

In one exemplary arrangement, the adhesive material is also disposed between a top peripheral edge of the printed circuit board assembly and a top peripheral edge of the housing assembly and between the bottom peripheral edge of the printed circuit board assembly and a bottom peripheral edge of the housing assembly such that an adhesive bond line is formed about a periphery of the printed circuit board assembly.

In one exemplary arrangement, the printed circuit board assembly includes one or more apertures therethrough to expose the adhesive material.

A method of assembling an image sensor system is also disclosed. The method comprises providing a housing assembly, with a lens receiving aperture formed therethrough and an image sensor assembly that that includes a lens assembly and a printed circuit board assembly. A portion of the lens assembly extends through the lens receiving aperture of the housing assembly. The lens assembly undergoes alignment. More specifically, the lens assembly includes a lens and an imager which are aligned in 6-axes so as to reduce roll, pitch and yaw tolerances.

Once aligned, adhesive material is applied along the thickness of the printed circuit board, i.e., a first peripheral edge of the printed circuit board assembly and the second peripheral edge of the printed circuit board assembly. In some exemplary arrangements, the adhesive material is applied to all four peripheral edges. The adhesive material is then cured to fix the printed circuit board to the housing assembly. UV light is directed toward the adhesive material to cure the adhesive. In one exemplary arrangement, apertures through the printed circuit board assembly allow for accessibility to the adhesive, thereby allowing the adhesive to cure effectively.

With this design, no additional mechanical parts are required (such as hoods, cover designs, etc.), leading to lower cost and easier inventory management. Nor are there any lens mounts or screws needed to assemble the imager. With this arrangement, better roll, pitch and yaw tolerance may be achieved over prior art configurations.

### BRIEF DESCRIPTION OF THE DRAWINGS

The foregoing and other features and advantages of the present disclosure will become apparent to those skilled in the art to which the present disclosure relates upon reading the following description with reference to the accompanying drawings. The disclosure described herein are for illustration purposes only and are not intended to limit the scope of the present disclosure in any way. In the drawings:

FIG. 1 is a diagrammatic isometric front view of an exemplary arrangement of an image sensor system according to the present disclosure;

FIG. 2 is a diagrammatic isometric back view of the image sensor system of FIG. 1, according to the exemplary arrangement of the present disclosure;

FIG. 3 is a diagrammatic partial elevated back view of the image sensor system of FIG. 1, according to an exemplary arrangement of the present disclosure;

FIG. 4 is a diagrammatic partial cross-sectional view of the image sensor system of FIG. 1, according to an exemplary arrangement of the present disclosure; and

FIG. 5 is an isometric view of an image sensor system according to an exemplary arrangement of the present disclosure.

### DETAILED DESCRIPTION

Referring now to the discussion that follows, and to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description. The following description is merely exemplary in nature and is not intended to limit the present disclosure, application, or uses.

As discussed herein, an image sensor system is disclosed that includes a lens assembly can be fixed relative to a housing assembly, which can allow for adjustment of an image sensor assembly along six (6) axes to minimize detrimental effects associated with a pitch, a roll, and/or a yaw of the image sensor assembly.

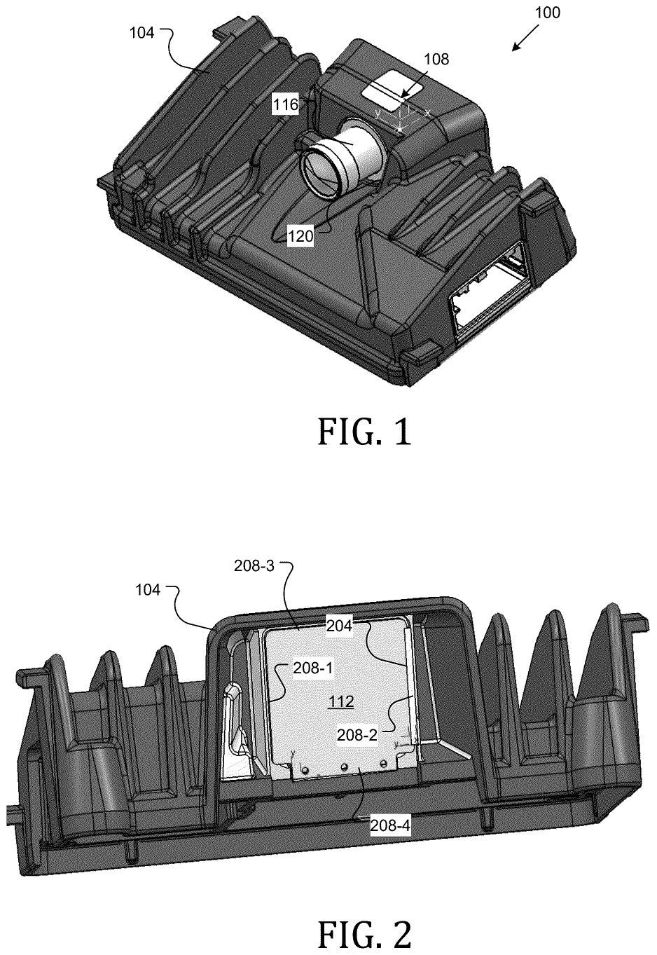

FIGS. 1 through 5 illustrate an exemplary arrangement of an image sensor system 100. The image sensor system 100 includes a housing assembly 104 and an image sensor assembly 108.

The housing assembly 104 may be configured to host an onboard processing unit that allows for processing of images from the image sensor assembly 108. The housing assembly 104 defines a lens receiving aperture 120 that extends between a rear side and front side of the housing 104.

The image sensor assembly 108 includes a printed circuit board assembly (PCBA) 112 (see FIG. 2) and a lens assembly 116. The image sensor assembly 108 can include an image sensor (not shown) that is attached, e.g., mounted, to a surface of the printed circuit board assembly 112.

As shown generally in FIG. 1, a portion of the lens assembly 116 is received within the lens receiving aperture 120. For example, a lens 122 extends outwardly from a front side of the housing 104, with a lens barrel of the lens assembly 116 being received within the lens receiving aperture 120.

Referring to FIGS. 2 through 4, once the lens assembly 116 is received within the housing assembly 104, the printed circuit board assembly 112 can be attached to the housing assembly 104. In an exemplary arrangement, an adhesive material 204, such as an epoxy cationic material, is dispensed along at least two of the peripheral edges 208-1 through 208-4 of the printed circuit board assembly 112 to attach the printed circuit board assembly 112 to housing assembly 104. For example, it is understood that in some exemplary arrangements, the adhesive material 204 is only dispensed along parallel peripheral edges 208-1, 208-2. In other exemplary arrangements, the adhesive material 204 is disposed on all of the peripheral edges 208-1-208-4.

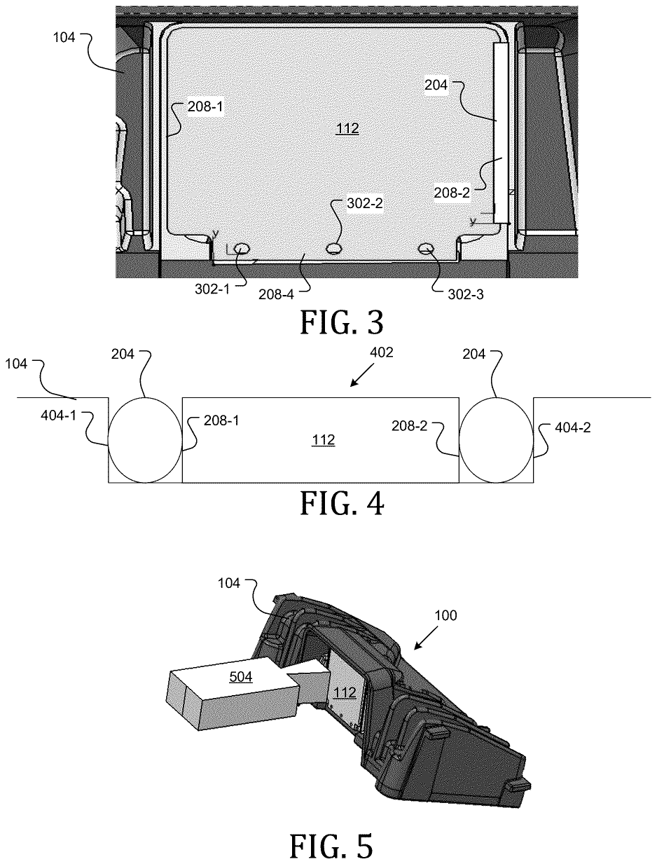

Referring to FIG. 3, the adhesive material 204 can be applied between a surface of housing assembly 104 and a surface of the printed circuit board assembly 112. As shown, the printed circuit board assembly 112 may define at least one, and in some exemplary arrangements, a plurality of apertures 302-1 through 302-3, which can allow for at least partial curing of the adhesive material 204. More specifically, the apertures 302-1 through 302-3 allow for UV light access for accomplishing UV curing.

As shown in FIG. 4, the housing assembly 104 may define a cavity 402, i.e., a region or an enclave, between edges 404-1, 404-2 to receive the printed circuit board assembly 112 therein. The adhesive material 204 can be applied within regions 406, 410, which comprise respective spaces defined between peripheral edge 208-1 and edge 404-1 and between peripheral edge 208-2 and edge 404-2.

It is understood that the printed circuit board assembly 112 can be manipulated prior to curing the adhesive material 204 to allow for proper orientation of the image sensor relative to the lens assembly 116, including the ability to achieve six-axis active alignment.

As shown in FIG. 5, an ultra-violet (UV) light emitting device 504 can be used to cure the adhesive material 204. Based on the application of the adhesive material 204 within at least regions 402, 404 (see FIG. 4), the ultra-violet light emitting device 504 can be positioned at least substantially perpendicular to an exposed surface of the printed circuit board assembly 112.

Accordingly, it is to be understood that the above description is intended to be illustrative and not restrictive. Many implementations and applications other than the examples provided would be apparent to those of skill in the art upon reading the above description. The scope of the disclosure should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future implementations. In sum, it should be understood that the invention is capable of modification and variation and is limited only by the following claims.

All terms used in the claims are intended to be given their plain and ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. An image sensor system comprising:
a housing assembly defining a cavity between a first edge. and a second edge of the housing assembly;
a printed circuit board assembly received within the cavity, the printed circuit board assembly having a first peripheral edge and a second peripheral edge; and
an adhesive material disposed between the first peripheral edge and the first edge of the housing assembly and between the second peripheral edge and the second edge of the housing assembly.

2. The image sensor system as recited in claim 1, wherein the housing assembly defines a lens receiving aperture that is configured to receive a lens barrel of a lens assembly.

3. The image sensor system as recited in claim 2, wherein the printed circuit board assembly is part of an image sensor assembly and includes a lens assembly.

4. The image sensor system as recited in claim 1, wherein the adhesive material comprises an epoxy cationic material.

5. The image sensor system as recited in claim 1, wherein the adhesive material is curable by a UV light.

6. The image sensor system as recited in claim 1, wherein the adhesive material disposed is also between a top peripheral edge of the printed circuit board assembly and a top peripheral edge of the housing assembly and between the bottom peripheral edge of the printed circuit board assembly and a bottom peripheral edge of the housing assembly such that an adhesive bond line is formed about a periphery of the printed circuit board assembly.

7. The image sensor system as recited in claim 1, wherein the printed circuit board assembly includes one or more apertures therethrough to expose the adhesive material.

8. A method of assembly an image sensor system, comprising,
providing a housing assembly that includes a lens receiving aperture formed therethrough and an image sensor assembly that includes a lens assembly and a printed circuit board assembly;
inserting a portion of the lens assembly through the lens receiving aperture of the housing assembly;
aligning the lens assembly,
applying adhesive material along a first peripheral edge of the printed circuit board assembly and the second peripheral edge of the printed circuit board assembly; and
curing the adhesive material to fix the printed circuit board to the housing assembly.

9. The method of claim 8, wherein the first and second peripheral edges are arranged parallel from each other and the adhesive is applied to parallel edges.

10. The method of either claim 8, wherein, adhesive is applied to third and fourth peripheral edges, wherein the third and fourth peripheral edges are arranged parallel to one another.

11. The method of claim 8, wherein UV light is applied toward the printed circuit board assembly to cure the adhesive material.

12. The method of claim 8, wherein UV light is shown through one or more apertures formed through the printed circuit board assembly to cure the adhesive material.
